(19) United States
(12) Patent Application Publication
(10) Pub. No.: US 2008/0154861 A1
(43) Pub. Date: Jun. 26, 2008

(54) SYSTEM AND METHOD FOR RETRIEVING DATA FROM DIFFERENT TYPES OF DATA SOURCES

(75) Inventors: CHUNG-I LEE, Tu-Cheng (TW); CHIEN-FA YEH, Tu-Cheng (TW); CHIU-HUA LU, Tu-Cheng (TW); WEI-QING XIAO, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/767,479

(22) Filed: Jun. 23, 2007

(30) Foreign Application Priority Data
Dec. 22, 2006 (CN) 200610157862.0

(51) Int. Cl. G06F 17/30

(52) U.S. Cl. 707/3; 707/E17.001

(57) ABSTRACT

A method for retrieving data, the method comprising the steps of: defining output parameters of an application server (20); defining an XQuery file for retrieving data from different types of data sources (10); providing a Web service executable file that is accessible by an application program installed in a client (50) that supports the Web service corresponding to the executable file; accessing the Web service executable file, and sending parameters of search requests to the Web service executable file; invoking the XQuery file according to the parameters of the search requests, and retrieving data from the data sources according to the XQuery file; and converting the searched data into the output parameters sent to the application program. A related system is also provided.

### BACKGROUND OF THE INVENTION

1. Field of the Invention

The present invention is related to a system and method for retrieving data from different types of data sources.

2. Description of Related Art

Web service is a software system designed to support interoperable machine to machine (M2M) interaction over a network. Web service is frequently just application programming interfaces (API) that can be accessed over a network, such as the Internet, and executed on a remote system hosting the requested services. Web service often works with many different systems, but in common usage the term refers to services that use simple object access protocol (SOAP)-formatted extensible markup language (XML) envelopes and have their interfaces described by Web services description language (WSDL).

Usually, in a design of an application program for a Web service platform, it is necessary to develop specific access programs for accessing different types of data sources, such as XML databases, relational databases, XML files and Webpages by the application program. The conventional solution is inconvenient and inefficient because a program developer would need to develop many different kinds of access programs.

Accordingly, what is needed is a system and method for retrieving data from different types of data sources, through which an application program installed in a client can retrieving data from different types of the data sources simultaneously.

### SUMMARY OF THE INVENTION

One preferred embodiment provides a system for retrieving data from different types of data sources. The system comprising an application server, a client and a plural of different types of data sources connected to the application server. The application server includes a parameter defining module, an XQuery file defining module, an accessing module, a data obtaining module, and a format converting module. The parameter defining module is used for defining output parameters of the application server. The XQuery file defining module is used for defining an XQuery file for retrieving data from the data sources. The accessing module is used for providing a Web service executable file that is accessible by an application program configured in the client, the application program supports the Web service corresponding to the executable file. The data obtaining module is used for invoking the XQuery file according to parameters of search request sent by the application program while accessing the Web service executable file, and for retrieving data from the data sources according to the XQuery file. The format converting module is used for converting the searched data into the output parameters sent to the application program.

Another preferred embodiment provides a method for retrieving data from different types of data sources. The method includes the steps of: defining output parameters of an application server; defining an XQuery file for retrieving data from different types of data sources; providing a Web service executable file that is accessible by an application program installed in a client that supports the Web service corresponding to the executable file; accessing the Web service executable file, and sending parameters of search requests to the Web service executable file; invoking the XQuery file according to the parameters of the search requests, and retrieving data from the data sources according to the XQuery file; and converting the searched data into the output parameters sent to the application program.

Other systems, methods, features, and advantages will be or become apparent to one skilled in the art upon examination of the following drawings and detailed description.

### BRIEF DESCRIPTION OF THE DRAWINGS

FIG. 1 is a schematic diagram of hardware configuration of a system for retrieving data from different types of data sources in accordance with one preferred embodiment;

FIG. 2 is a schematic diagram of function modules of an application server in FIG. 1; and

FIG. 3 is a flowchart of a method for retrieving data from different types of data sources in accordance with one preferred embodiment.

### DETAILED DESCRIPTION OF THE INVENTION

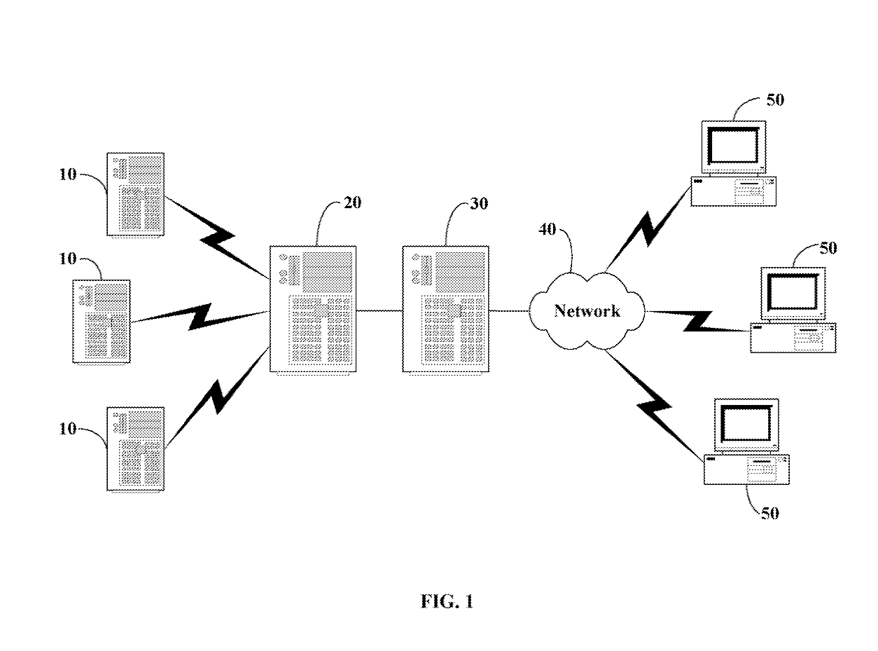

FIG. 1 is a schematic diagram of hardware configuration of a system for retrieving data from different types of data sources in accordance with one preferred embodiment. The hardware configuration may typically include a plurality of different types of data sources 10, an application server 20, a universal description, discovery, and integration (UDDI) server 30, and a plurality of clients 50. The data sources 10 connect with the application server 20, and the application server 20 is further connected to the UDDI server 30. The clients 50 are connected with the UDDI server 30 via a network 40.

The data sources 10 may include at least one XML database server, at least one relational database servers, at least one XML file servers, and at least one Web page servers. The data sources 10 are used for providing data accessible by the application server 20.

The application server 20 and the UDDI server 30 may be desktop servers, rack mount servers, pedestal servers, or blade servers. The application server 20 is used for providing a Web service executable file accessible by an application program that is configured in any of the clients 50, retrieving the data from the data sources 10 according to parameters of search requests sent from the application program, and sending searched results to the application program. The UDDI server 30 provides an index of the searched results, through which the application program can directly access the application server 20 to obtain the searched results.

The network 40 may be an intranet, the Internet, or any other suitable type of communications link.

Each of the clients 50 may be a notebook computer, a desktop computer, a personal digital assistant (PDA), or any other terminal access devices. Each of the clients 50 has an application program that supports the Web service corresponding to the executable file. The application program on each of the clients 50 can access the application server 20, and further retrieve the data from the data sources 10 via the application server 20. For example, the application program may be a foreign exchange quotation program that supports the Web service. When the foreign exchange quotation program is invoked, the foreign exchange quotation program sends parameters of the search requests corresponding a foreign exchange quotation to the application server 20 via the UDDI server 30, then the application server 20 retrieves data corresponding the foreign exchange quotation from the data sources 10 according to the parameters, and returns the searched data as searched results to the foreign exchange quotation program.

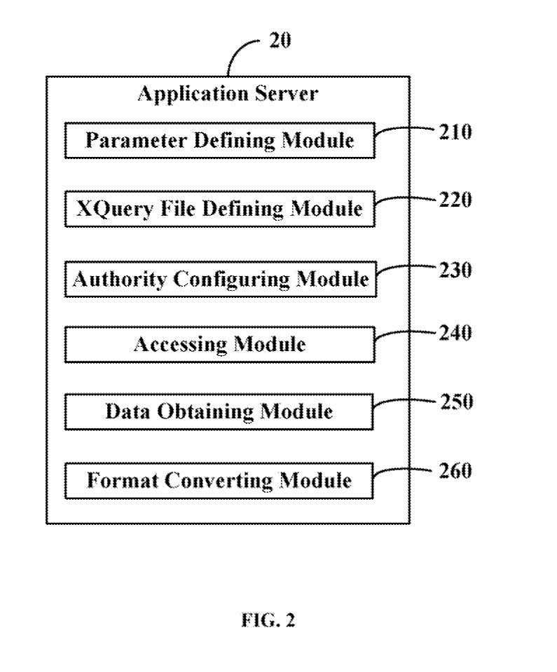

FIG. 2 is a schematic diagram of function modules of the application server 20. The application server 20 mainly includes a parameter defining module 210, an XQuery file defining module 220, an authority configuring module 230, an accessing module 240, a data obtaining module 250, and a format converting module 260.

The parameter defining module 210 is used for defining output parameters of the application server 20 when the searched results are transmitted to the application program via the UDDI server 30. For example, the output parameters may include a currency name, a currency code, and an exchange rate of the searched results of the foreign exchange quotation program.

The XQuery file defining module 220 is used for defining an XQuery file for retrieving the data from the data sources 10.

The authority configuring module 230 is used for pre-configuring user access rights to the data sources 10.

The accessing module 240 is used for providing a Web service executable file that is accessible by the application program. The Web service is implemented with the Web services Description Language (WSDL). When the application program accesses the Web service executable file, the application program sends parameters of search requests to the Web service executable file.

The data obtaining module 250 is used for invoking the XQuery file according to the parameters of the search requests, and retrieving the data from the data sources 10 according to the XQuery file.

The format converting module 260 is used for converting the searched data into the output parameters sent to the application program.

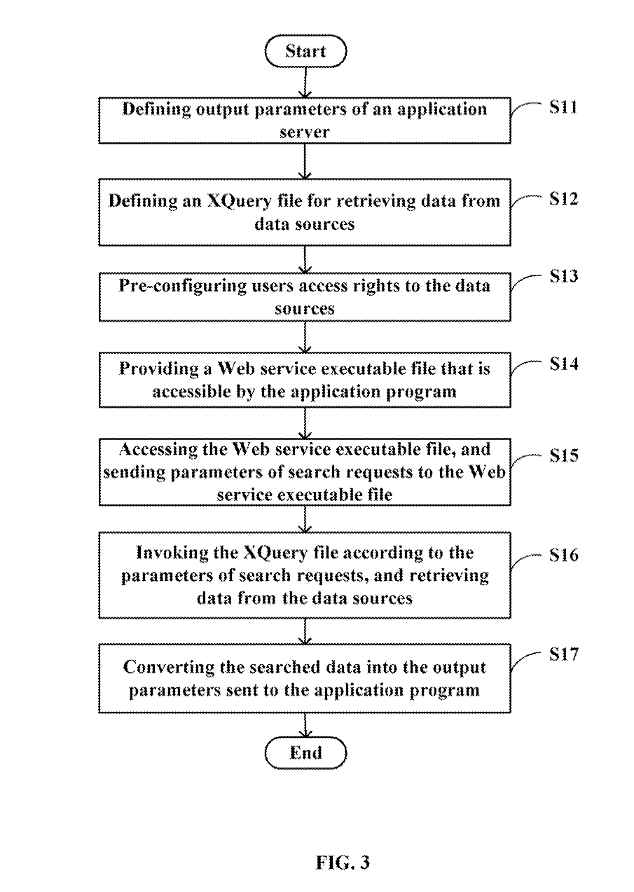

FIG. 3 is a flowchart of a method for retrieving data from different types of data sources in accordance with one preferred embodiment.

In step S11, the parameter defining module 210 defines the output parameters of the application server 20.

In step S12, the XQuery file defining module 220 defines an XQuery file for retrieving data from the data sources 10.

In step S13, the authority configuring module 230 pre-configures user access rights to the data sources 10.

In step S14, the accessing module 240 provides a Web service executable file that is accessible by the application program.

In step S15, the application program accesses the Web service executable file, and sends parameters of search requests to the Web service executable file.

In step S16, the data obtaining module 250 invokes the XQuery file according to the parameters of the search requests, and retrieving data from the data sources 10 according to the XQuery file.

In step SI 7, the format converting module 260 converts the searched data into the output parameters sent to the application program.

It should be emphasized that the above-described embodiments of the preferred embodiments, particularly, any “preferred” embodiments, are merely possible examples of implementations, merely set forth for a clear understanding of the principles of the invention. Many variations and modifications may be made to the above-described preferred embodiment(s) without departing substantially from the spirit and principles of the invention. All such modifications and variations are intended to be included herein within the scope of this disclosure and the above-described preferred embodiment(s) and protected by the following claims.

What is claimed is:

1. A system for retrieving data from different types of data sources, the system comprising an application server, a client and a plural of different types of data sources connected to the application server, the application server comprising:
a parameter defining module for defining output parameters of the application server;
an XQuery file defining module for defining an XQuery file for retrieving data from the data sources;
an accessing module for providing a Web service executable file that is accessible by an application program configured in the client, the application program being configured to support the Web service corresponding to the executable file;
a data obtaining module for invoking the XQuery file according to parameters of search request sent by the application program while accessing the Web service executable file, and for retrieving data from the data sources according to the XQuery file; and
a format converting module for converting the searched data into the output parameters sent to the application program.

2. The system according to claim 1, wherein the application server further comprises an authority configuring module for pre-configuring user access rights to the data sources.

3. A computer-based method for retrieving data from different types of data sources, the method comprising the steps of:
defining output parameters of an application server;
defining an XQuery file for retrieving data from different types of data sources;
providing a Web service executable file that is accessible by an application program installed in a client that supports the Web service corresponding to the executable file;
accessing the Web service executable file, and sending parameters of search requests to the Web service executable file;
invoking the XQuery file according to the parameters of the search requests, and retrieving data from the data sources according to the XQuery file; and
converting the searched data into the output parameters which are sent to the application program.

4. The method according to claim 3, further comprising the step of pre-configuring user access rights to the data sources.
